(19) United States
(12) Patent Application Publication
(10) Pub. No.: US 2008/0168928 A1
(43) Pub. Date: Jul. 17, 2008

(54) Concrete Composition Containing Atomized Steelmaking Slag And Concrete Blocks Using The Concrete Composition

(75) Inventors: Ok-Soo Oh, Seoul (KR); Sang-Yoon Oh, Seoul (KR)

Correspondence Address: MCDERMOTT WILL & EMERY LLP, 18191 VON KARMAN AVE., SUITE 500, IRVINE, CA, 92612-7108, US

(73) Assignee: ECOMAISTER CO. LTD., Seo-gu, Incheon (KR)

(21) Appl. No.: 11/914,549

(22) PCT Filed: May 20, 2006
(86) PCT No.: PCT/KR06/01900

§ 371 Date: Nov. 15, 2007

(30) Foreign Application Priority Data
May 20, 2005 (KR) 10-2005-0042590

(51) Int. Cl. C04B 5/00

(52) U.S. Cl. 106/789

(57) ABSTRACT

Provided is a concrete composition containing atomized steelmaking slag balls (also referred to as PS balls). More specifically, the present invention provides a concrete composition containing sand wherein the sand is partially or completely replaced with atomized steelmaking slag balls. The concrete composition of the present invention is comprised of water, cement, coarse aggregates having a particle size of more than 5 mm, fine aggregates having a particle size of less than 5 mm, optional additives, and the balance of other inevitable impurities, wherein the fine aggregates include more than 30% by volume of atomized slag balls.

### TECHNICAL FIELD

The present invention relates to a concrete composition containing atomized steelmaking slag balls (also referred to as PS (Precious Slag) balls). More specifically, the present invention relates to a concrete composition containing sand wherein the sand is partially or completely replaced with atomized steelmaking slag balls.

### BACKGROUND ART

Generally, concrete is a compacted mixture of water-kneaded cement paste and construction aggregates, using a hardening phenomenon of cement via reaction with water. Standard requirements for the concrete are well defined in Standard Specification of Concrete. Upon reviewing this Standard Specification, it can be seen that concrete is composed of cement, water, fine and coarse aggregates and concrete admixtures and the like.

According to Standard Specification of Concrete, the fine aggregates among these ingredients refer to aggregates meeting requirements of the particle size distribution as set forth in Table 1 below. In addition to specified ranges and requirements given in Table 1, in order to guarantee superior qualities of concrete, the following conditions should be satisfied: cleanness, high strength and durability, and being free of harmful substances such as dust, soil, organic impurities, salts and the like. Further, concrete should have a particle shape close to a cubic or spherical form, surface texture having high adhesivity to cement paste, adequate required weight so as to avoid the risk of material separation due to excessive light-weightness, and optionally, abrasion resistance.

TABLE 1

| | |
|---|---|
| Mesh dimension (size) | Wt % of aggregates passing through sieve |

| | | |
|---|---|---|
| 10 | mm | 100% |
| 5 | mm | 95-100% |
| 2.5 | mm | 85-100% |
| 1.2 | mm | 50-85% |
| 0.6 | mm | 20-60% |
| 0.3 | mm | 10-30% |
| 0.15 | mm | 2-10% |

Meanwhile, river sand has been primarily used as materials for the fine aggregates, but increasing concern for environmental protection has raised a trend of gradual decrease in use of the river sand. Therefore, utilization of sea sand, crushed sand or reclaimed sand increases gradually as the substitute for the river sand. However, similar to the river sand, indiscriminate sea sand mining may also lead to destruction of nearshore areas, which therefore triggers transition of mining methods from nearshore sand mining to offshore sand mining, thus presenting numerous disadvantages such as increased collection costs, need for special treatment due to the presence of salts, and need to take caution upon use thereof. In addition, crushed sand is inferior in quality thereof, which may incur increased incidental expenses for additional treatment. Further, reclaimed sand also suffers from various difficulties associated with application thereof to high-quality concrete such as unstable and variable qualities.

Therefore, many efforts have been continued to find a substitute for conventional fine aggregates. As a result, various substitute aggregates such as blast furnace slag (BF slag) aggregates, copper slag aggregates and lead slag aggregates were developed and the necessary requirements for such substitutes were established by Korean Industrial Standards (KS).

Of these substitute aggregates, the blast furnace slag is used as fine aggregates having an adequate particle size by crushing massive granulated slag (water-quenched slag). However, this type of slag exhibits hydraulicity and therefore is vulnerable to conglomeration of particles in high-temperature and high-humidity environment. For stable storage, it is required to separately store cementable slag and non-cementable slag from each other, or it is needed to store slag in admixture with natural aggregates. As such, the blast furnace slag has various problems that make it unsuitable as fine aggregates, but has rather suitable properties for use in cement clinker and is thus not widely used as the fine aggregates.

Copper slag aggregates are produced by water-quenching or air-cooling molten slag, which is generated upon making copper from copper sulfide ores via a variety of processes including continuous smelting, reverberatory furnace smelting and flash smelting, and adjusting a particle size of the slag to a desired level. Due to large specific gravity, it is recommended to use copper slag in admixture with natural sand. In addition, it is stipulated that such copper slag aggregates must have confirmed chemical stability according to the corresponding test method specified by KS and it is thus difficult to use due to a complicated procedure.

Lead slag aggregates are produced by water-quenching or air-cooling molten slag, which is generated upon continuous melting and reducing of lead ores in a smelting furnace, thereby adjusting a particle size of the slag to a desired level. However, utilization of lead slag as concrete aggregates was pioneered in Korea, and availability thereof was not yet completely verified worldwide. In addition, the probability of heavy metal (Pb) elution limits application of lead slag to within a narrow range, and therefore lead slag are not so suitable for fine aggregates.

In order to solve problems associated with utilization of blast furnace slag (BF slag), copper slag or lead slag, a technique of using a converter slag was proposed. The converter slag has various advantages such as a low content of heavy metals as compared to lead slag, a low specific gravity as compared to copper slag, and no hydraulicity unlike blast furnace slag.

However, from a standpoint of the characteristics of converter operation in which basic operation is performed by increasing a CaO content, utilization of the converter slag is accompanied by problems such as degradation pathways by hydration of CaO and extraction of massive slag, which thus present a need for aging over a significantly prolonged period of time to serve as concrete aggregates. Therefore, unfortunately, the converter slag cannot be directly utilized as concrete aggregates in a state discharged from steel making processes.

In summary, natural fine aggregates used in concrete suffer from problems such as limited exploitation amount, a need for additional treatments and the like. Further, substitute fine aggregates for replacing such natural aggregates also exhibit limited application thereof due to problems associated with stability and additional treatments.

### DISCLOSURE OF INVENTION

### Technical Problem

Therefore, the present invention has been made in view of the above problems, and it is an object of the present invention to provide a concrete composition comprising fine aggregates with no elution of heavy metals and any other undesirable components and no need for special pre-treatments or inspection processes, and that has physical properties superior to conventional concrete composition.

### Technical Solution

In accordance with the present invention, the above and other objects can be accomplished by the provision of a concrete composition comprising water, cement, coarse aggregates having a particle size of more than 5 mm, fine aggregates having a particle size of less than 5 mm, optional additives, and the balance of other inevitable impurities, wherein the fine aggregates include more than 30% by volume of atomized slag balls. The additives refer to an additives that can be chosen and used easily by person with ordinary skill in the art to which the invention pertains.

Here, when it is intended to use the above concrete composition as a concrete composition for high-strength lean-mix concrete, it is preferred that the fine aggregates include more than 50% by volume of atomized slag balls.

Preferably, the lean-mix concrete composition comprises 50 to 80 kg of water, 140 to 170 kg of cement, 800 to 1,600 kg of slag balls, 0 to 600 kg of sand, 1,200 to 1,300 kg of coarse aggregates, optional additives, and the balance of other inevitable impurities, per m³ of the concrete composition.

When it is desired to use the concrete composition as a concrete composition for surface-layer concrete having high strength and high abrasion resistance, the fine aggregates preferably include more than 30% by volume of atomized slag balls.

Preferably, the surface-layer concrete composition comprises 140 to 160 kg of water, 300 to 350 kg of cement, 200 to 1,000 kg of slag balls, 0 to 500 kg of sand, 1,000 to 1,100 kg of coarse aggregates, optional additives, and the balance of other inevitable impurities, per m³ of the concrete composition.

In addition, for a normal-strength concrete composition, the fine aggregates preferably include 30 to 50% by volume of atomized slag balls.

The normal-strength concrete composition comprises 150 to 180 kg of water, 300 to 350 kg of cement, 300 to 550 kg of slag balls, 370 to 520 kg of sand, 1,000 to 1,100 kg of coarse aggregates, optional additives, and the balance of other inevitable impurities, per m³ of the concrete composition.

Further, where it is desired to use the above concrete composition as a concrete composition for a radioactive-shielding material, the fine aggregates preferably include more than 50% by volume of atomized slag balls.

Preferably, the radioactive-shielding concrete composition comprises 160 to 180 kg of water, 450 to 550 kg of cement, 500 to 1,000 kg of precious slag (PS) balls, 0 to 370 kg of sand, 870 to 970 kg of coarse aggregates, optional additives, and the balance of other inevitable impurities, per m³ of the concrete composition.

As another example of the high-strength concrete composition containing slag balls, mention may be made of a high-strength cement block comprising 2 to 4 parts by volume of blast furnace slag (BF slag) and 4 to 6 parts by volume of slag balls per volume of cement.

Preferably, the blast furnace slag and slag balls constituting the cement block are contained in a ratio of 2:6 to 4:4 (v/v).

### Advantageous Effects

According to the present invention, it is possible to obtain a superior concrete composition having improved strength, radioactive-shielding capability and abrasion resistance as compared to conventional concrete compositions, and using a reduced amount of a high-performance water reducing agent. Further, the present invention also provides advantages capable of utilizing converter or electric furnace slag, which requires high-disposal costs, as resources for the concrete composition.

### BEST MODE FOR CARRYING OUT THE INVENTION

As used herein, the term “atomized” or “atomizing” refers to a process involving charging liquid slag, which is produced as a by-product of steelmaking processes in steelmaking plants, in a slag pot, flowing the steelmaking slag into a zone on which high-pressure gas mixed with water is sprayed, such that the steelmaking slag is supplied with kinetic energy of the mixed gas and is then divided into a great numbers of fine liquid droplets, and water- or air-cooling the divided fine liquid droplets having spherical shapes due to surface energy thereof, thereby obtaining solid spherical balls. Utilizable steelmaking slag may include, for example converter slag, electric furnace slag and the like. Secondary smelter slag, which was treated in a slag ladle, may also be used.

As a result of a variety of extensive and intensive studies on physical properties of atomized steelmaking slag balls as above, the inventors of the present invention have discovered that when the atomized slag balls are used as fine aggregates for a concrete composition, it is possible to improve physical properties of concrete and it is also possible to solve problems suffered by conventional substitute fine aggregates. The present invention has been completed based on these findings.

First, after comparison between characteristics of fine aggregates, which are required to be met by Korean Industrial Standards, and characteristics of slag balls utilized in the concrete composition of the present invention, characteristics of the concrete composition utilizing the slag balls will be described hereinafter.

1. Required Particle Size of Fine Aggregates

The required particle size of fine aggregates is as defined in Table 1 hereinbefore. For comparison with these specified requirements, the particle size of slag balls utilized in the present invention is given in Table 2 below.

TABLE 2

| | | Required standards | Particle size |
|---|---|---|---|
| Mesh dimension | | of particle size | distribution of slag |
| (size) | | distribution (wt %) | balls (wt %) |
| 10 | mm | 100% | 100 |
| 5 | mm | 95-100% | 100 |
| 2.5 | mm | 85-100% | 95 |
| 1.2 | mm | 50-85% | 80 |
| 0.6 | mm | 20-60% | 52 |
| 0.3 | mm | 10-30% | 17 |
| 0.15 | mm | 2-10% | 3 |

As shown in Table 2, it can be seen that the particle size of slag balls utilized in the present invention sufficiently meets the particle size stipulated by KS.

Of course, by adjustment of manufacturing conditions and additional screening processes to cope with modification of standardization, it is possible to sufficiently control the particle size of the slag balls to an optimal level as desired. Therefore, it is to be understood that the particle size of the slag balls described in the present specification is only exemplary of some of the many possible embodiments. That is, for example, the particle size of the slag balls may be sufficiently varied with modification of various conditions such as blast pressure of mixed gas, a supply rate of liquid slag, a nozzle angle, slag temperature and the like. In addition, a desired particle size of slag balls may also be sufficiently selected by a screening process of the slag balls through a screen.

2. Shape of Fine Aggregates

The shape of fine aggregates is required to be cubic or spherical, and slag balls of the present invention, as already described hereinbefore, have spherical shapes due to surface energy thereof in the state of molten liquid droplets, thereby satisfying shape requirements necessary for fine aggregates.

3. Hardness and Abrasion Resistance

Slag balls are produced by quenching molten steelmaking slag and are composed of various components including CaO, SiO₂, MgO, Fe₂O₃, Al₂O₃ and MnO. These constituent elements are not present in single phases, but instead combine with other components to form complex phases. Quenching of the complex phases thus formed results in very high hardness and as a result, superior abrasion resistance.

4. Other Physical Properties

Slag balls are produced by atomizing steelmaking slag, as discussed before, and therefore have a highly clean surface due to the absence of foreign materials such as dust and soil thereon.

As such, the slag balls contained in the concrete composition of the present invention meet all performance requirements specified for concrete fine aggregates. In addition, upon using the above slag balls as constituent component of the concrete composition, it is possible to prepare a concrete composition having superior physical properties as compared to conventional concrete compositions.

Hereinafter, characteristics and advantages of a concrete composition according to the present invention will be described.

The concrete composition according to the present invention comprises water, cement, coarse aggregates having a particle size of more than 5 mm, fine aggregates having a particle size of less than 5 mm, optional additives, and the balance of other inevitable impurities, wherein the fine aggregates include more than 30% by volume of atomized slag balls.

The subject concrete compositions of the present invention are concrete compositions which are not particularly bound to intended applications and thereby composition systems. Any concrete compositions fall within the scope of technical idea of the present invention as long as they are concrete compositions containing atomized slag balls as more than 30% of fine aggregates, based on the volume.

However, specific conditions of the concrete composition intended for individual applications so as to obtain more advantageous effects are disclosed in the following Examples and the accompanying dependent claims.

The concrete composition containing more than 30% by volume of atomized slag balls in fine aggregates has the following characteristics.

Strength (compressive strength, tensile strength and flexural strength): Slag balls are produced by atomizing steelmaking slag, as previously discussed, and the presence of large amounts of iron oxides contained in the steelmaking slag leads to enhanced adhesion between the iron oxide component and paste. In addition, the slag balls have a spherical shape which allows for homogeneous mixing of slag balls with the paste, and therefore adhesion performance of the paste becomes superior. As a result, a slag ball-containing concrete composition exhibits enhanced compressive strength, tensile strength and flexural strength, as compared to conventional concrete compositions.

Abrasion resistance: Due to high hardness and strength of the slag balls as described above, incorporation of the slag balls into the concrete composition leads to overall increases in strength of the concrete composition.

Homogeneous miscibility: Slag balls have spherical and smooth surface morphology, which facilitates homogeneous mixing of slag balls within the concrete composition. Consequently, it is very economical in that an amount of a high-performance water reducing agent to be used can be significantly reduced.

Radioactive-shielding capability: Due to iron oxide components contained in slag balls, the slag balls exhibit very high specific gravity of 3.4 to 3.8, as compared to low specificgravity of 2.55 to 2.65 of sand which is primarily used as fine aggregates. Therefore, a unit weight of the slag balls is relatively high. Hence, the slag ball-containing concrete composition exhibits superior radioactive-shielding capability due to the high-unit weight thereof.

In conclusion, the concrete composition according to the present invention uniformly possesses superior characteristics as described above and it is therefore possible to obtain a concrete composition having significantly improved characteristics by adjusting a ratio of the slag balls contained in fine aggregates, as will be described below, depending upon specific applications in which the concrete composition is used.

Concrete Composition for High-Strength Lean-Mix Concrete

Lean-mix concrete refers to concrete comprised of 50 to 80 kg of water, 140 to 170 kg of cement 600 to 1200 kg of sand, 1,200 to 1,300 kg of coarse aggregates, optional additives, and the balance of other inevitable impurities, per m³ of the concrete composition, when sand is used alone as common fine aggregates, and having high strength due to a low mixing ratio of cement as compared to conventional concrete.

When more than 50% by volume of fine aggregates in the high-strength lean-mix concrete is replaced with slag balls, it is possible to achieve significantly highly increasing effects in compressive strength, tensile strength and elastic modulus, as compared to concrete using only natural aggregates. Therefore, use of the lean-mix concrete as a concrete base can provide effects of increases in load-bearing capacity of the top-pavement layer. Here, when the ratio of slag balls is less than 50% by volume, strength-enhancing effects are insignificant. For this reason, slag balls should be included in an amount of more than 50% by volume in fine aggregates.

As such, upon taking into account the specific gravity and ratio of slag balls, the lean-mix concrete composition of the present invention may be a concrete composition comprising 50 to 80 kg of water, 140 to 170 kg of cement, 800 to 1,600 kg of slag balls, 0 to 600 kg of sand, 1,200 to 1,300 kg of coarse aggregates, optional additives, and the balance of other inevitable impurities, per m³ of the concrete composition. The additives refer to an additives that can be chosen and used easily by person with ordinary skill in the art to which the invention pertains.

Concrete Composition for Surface-Layer Concrete

The surface-layer concrete refers to concrete comprised of 140 to 160 kg of water, 300 to 350 kg of cement, 650 to 750 kg of fine aggregates, 1,000 to 1,100 kg of coarse aggregates, optional additives, and the balance of other inevitable impurities, per m³ of the concrete composition, when sand is used alone as common fine aggregates.

When the surface-layer concrete is intended for concrete requiring high strength and high abrasion resistance and therefore more than 30% by volume of fine aggregates of the surface-layer concrete is replaced with slag balls, it is possible to achieve about 20% or higher strength-enhancing effects of flexural strength as compared to that of the surface-layer concrete using only natural aggregates, and it is also possible to reduce maintenance costs of the surface-layer concrete due to superior abrasion resistance of slag balls per se. If the replacement ratio of slag balls is less than 30% by volume, increasing effects of strength and abrasion resistance are insufficient.

Therefore, upon taking into account the ratio of slag balls to be used, the surface-layer concrete composition of the present invention may be a concrete composition comprising 140 to 160 kg of water, 300 to 350 kg of cement, 200 to 1,000 kg of slag balls, 0 to 500 kg of sand, 1,000 to 1,100 kg of coarse aggregates, optional additives, and the balance of other inevitable impurities, per m³ of the concrete composition. The additives refer to an additives that can be chosen and used easily by person with ordinary skill in the art to which the invention pertains.

Normal-Strength Concrete Composition

The normal-strength concrete refers to concrete comprised of 150 to 180 kg of water, 300 to 350 kg of cement, 740 to 790 kg of fine aggregates, 1,000 to 1,100 kg of coarse aggregates, optional additives, and the balance of other inevitable impurities, per m³ of the concrete composition, when sand is used alone as common fine aggregates.

When the ratio of slag balls replacing fine aggregates is set within a range of 30 to 50% by volume, conventional normal-strength concrete can also achieve greatly improved compressive strength, tensile strength and flexural strength of concrete and further, due to homogeneous mixing-enhancing effects of slag balls, reduction in an amount of a high-performance water reducing agent to be used. When the replacement ratio of slag balls is less than 30% by volume, strength-enhancing effects are decreased. On the contrary, when the replacement ratio exceeds 50% by volume, this may result in problems such as material separation of slag balls and downward sedimentation of slag balls, upon pouring concrete and an excessive increase in a self-weight of the finally poured concrete.

Therefore, upon taking into consideration the ratio of slag balls to be used, the normal-strength concrete composition of the present invention may be a concrete composition comprising 150 to 180 kg of water, 300 to 350 kg of cement, 300 to 550 kg of slag balls, 370 to 520 kg of sand, 1,000 to 1,100 kg of coarse aggregates, optional additives, and the balance of other inevitable impurities, per m³ of the concrete composition. The additives refer to an additives that can be chosen and used easily by person with ordinary skill in the art to which the invention pertains.

Radioactive-Shielding Concrete Composition

In order to enhance radioactive-shielding capability of concrete, it is necessary to lower radiability by increasing a saturated surface-dry density (SSDD) of concrete. When more than 50% by volume of fine aggregates in the concrete composition according to the present invention is replaced with slag balls, it is possible to increase saturated surface-dry density (SSDD) of concrete due to high specific gravity of slag balls. The radioactive-shielding concrete composition, in which fine aggregates are replaced with 50% by volume of slag balls, may be a concrete composition comprising 160 to 180 kg of water, 450 to 550 kg of cement, 500 to 1,000 kg of PS balls, 0 to 370 kg of sand, 870 to 970 kg of coarse aggregates, optional additives, and the balance of other inevitable impurities, per m³ of the concrete composition. The additives refer to an additives that can be chosen and used easily by person with ordinary skill in the art to which the invention pertains.

Due to numerous advantageous effects of slag balls as described above, technical ideas of the present invention can be applied to various kinds of concrete compositions.

In conjunction with advantageous effects resulting from addition of slag balls to the concrete composition, further addition of granulated blast furnace slag may provide increased strength, and may also solve the problem of an increased unit weight of the concrete composition caused from increasing specific gravity of the slag balls.

That is, the granulated blast furnace slag has low compressive strength and therefore cannot be used in the whole quantity for concrete compositions requiring high-compressive strength, such as cement bricks. However, upon using the granulated blast furnace slag in conjunction with slag balls which have high-compressive strength while exhibiting large specific gravity, it is possible to exert mutual complementation effects therebetween, thus making it suitable for high-strength concrete composition, for example cement bricks, suffering from limitation of unit weight thereof. When it is desired to manufacture concrete blocks using the granulated blast furnace slag, the most optimal ratio is preferred to include 2 to 4-fold volume of granulated blast furnace slag and 4 to 6-fold volume of slag balls, relative to the volume of cement. In addition, the most optimal mixing ratio between the granulated slag and slag balls is preferably in the range of 2:6 to 4:4 (vlv).

### Mode for the Invention

### Example 1

This example was given to illustrate the mix design of lean-mix concrete and preparation thereof.

According to a specified mix formula given in Table 3 below, lean-mix concrete bases were manufactured which respectively correspond to the case using only sand as fine aggregates and the case using 50% by volume of slag balls in fine aggregates. As disclosed, slag balls have higher specific gravity than conventional sand and therefore were included in larger amounts than sand, on the basis of weight. Compaction tests for the respective lean-mix concrete bases were carried out according to two types of methods, i.e., field roller compaction and compaction method E specified in KS F2312. In order to evaluate the test results, strength of test specimens was determined by preparing a cylindrical specimen having a diameter of 15 cm and a height of 30 cm from the concrete manufactured by compaction method E of KS F2312 and a core specimen from the concrete prepared by field roller compaction, respectively.

TABLE 3

| | | | Aggregates (kg) | | |
|---|---|---|---|---|---|
| Example | | | 32□(coarse | | |
| No. | Cement (kg) | Water (kg) | aggregates) | Sand | Slag balls |
| Comp. EX. 1 | 160 | 85 | 1273 | 1148 | 0 |
| Ex. 1 | 158 | 60 | 1273 | 574 | 818 |

Construction of the lean-mix concrete bases is generally carried out by processes including steps of spreading a concrete mix using an asphalt paver, first rolling with a vibration roller, secondary rolling with a tire roller and third rolling with a tandem roller. The thickness of the thus formed concrete bases is typically about 15 cm. In this example, in order to compare compressive strength between two concrete bases, core specimens were taken from the above concrete bases by excavating a selected layer to a depth of about 15 cm. In order to prevent construction defects that may occur due to a thickness difference at the excavation site of the selected layer, lean-mix concrete was spread using an excavator, followed by pre-construction with the vibration roller, such that there was no occurrence of a thickness difference between the selected layer and longitudinal section, prior to spreading of the concrete mix by the asphalt paver. Subsequent construction processes were performed in the same manner as in general construction of the lean-mix concrete base.

Test results on the thus-prepared specimens are shown in Table 4 below.

TABLE 4

| | | Compaction according to | | | | | |
|---|---|---|---|---|---|---|---|
| | | Method E, KS | | | | | |
| | | F2312(Laboratory) | | | Field roller compaction | | |
| | | Compressive | Tensile | | Compressive | Tensile | |
| Example | Aging | strength | strength | Elastic | strength | strength | Elastic |
| No. | (days) | (MPa) | (MPa) | modulus | (MPa) | (MPa) | modulus |
| Comp. | 4 | 6.4 | 0.77 | 1.05 | — | | — |
| Ex. 1 | 7 | 6.7 | 1.03 | 1.40 | 7.1 | 1.03 | 1.40 |
| | 28 | 10.8 | 1.75 | 1.86 | 11.1 | 1.22 | 1.71 |
| Ex. 1 | 4 | 6.9 | 0.92 | 1.41 | — | — | — |
| | 7 | 9.3 | 1.35 | 2.09 | 9.3 | 1.35 | 2.09 |
| | 28 | 15.4 | 2.11 | 2.58 | 12.3 | 1.41 | 1.82 |

As shown in Table 4, upon examining compressive strength of specimens on Day 7 of aging, the concrete composition to which slag balls were added according to the present invention, exhibited 39% (Laboratory compaction) and 31% (Field roller compaction) improvement in compressive strength thereof, as compared to a concrete composition to which natural sand was added alone. In addition, it could be confirmed that the compressive strength of the concrete compositions on Day 28 of aging exhibited 46% (Laboratory compaction) and 11% (Field roller compaction) improvement in Example 1 of the present invention, as compared to Comparative Example 1.

In addition to compressive strength, it could be seen that tensile strength and elastic modulus were also significantly improved in Example 1 of the present invention, as compared to Comparative Example 1 using natural sand.

### Example 2

Composition formula for preparing surface-layer concrete so as to examine improving effects of compressive strength and flexural strength by incorporation of slag balls is given in Table 5 below.

TABLE 5

| | | | Volume | | | | | |
|---|---|---|---|---|---|---|---|---|
| | | | ratio | | | | | |
| | Water/ | Fine | of slag | Unit Weight (Kg/m³) | | | | |
| Example | Cement | aggregate | balls in | | | | Coarse aggre- | Salg |
| No. | (%) | ratio(%) | fine | Water | Cement | Sand | gate(32 mm) | balls |
| Comp. | 43.1 | 40 | 0% | 161 | 374 | 694 | 1057 | — |
| Ex. 2 | | | | | | | | |
| Ex. 2-1 | 45 | 40 | 30% | 153 | 340 | 499 | 1082 | 214 |
| Ex. 2-2 | 45 | 40 | 50% | 145 | 332 | 364 | 1104 | 509 |

Here, the fine aggregate ratio refers to a volume fraction of fine aggregates including sand and slag balls contained in the total aggregates, and is expressed by the following equation:

Fine aggregate ratio(%)=(sand+slag balls)/(sand+slag balls+coarse aggregates)×100

Example 2-1 represents the condition in which the proportion of slag balls in the fine aggregate is 30%, and Example 2-2 represents the condition in which the proportion of slag balls in the fine aggregate is 50%.

Compressive strength and flexural strength of surface-layer concrete, which was manufactured according to the composition formula set forth in Table 5, were measured. The results thus obtained are shown in Table 6 below.

TABLE 6

| | | Strength (MPa) | |
|---|---|---|---|
| Example No. | Aging (days) | Compressive strength | Flexural strength |
| Comp. Ex. 2 | 3 | 23.4 | — |
| | 7 | 32.5 | 4.3 |
| | 28 | 42.1 | 5.2 |
| Ex. 2-1 | 3 | 25.0 | — |
| | 7 | 33.0 | 4.9 |
| | 28 | 41.0 | 6.0 |
| Ex. 2-2 | 3 | 24.4 | — |
| | 7 | 34.3 | 5.3 |
| | 28 | 42.7 | 6.4 |

From the results of Table 6 corresponding to anaging period, it can be seen that concrete compositions of Examples 2-1 and 2-2 according to the present invention exhibited significantly higher strength values, as compared to a concrete composition of Comparative Example 2 to which natural sand was added alone. In addition, it can be additionally seen that increasing compositions.

### Example 3

In order to improve strength of normal-strength concrete, concrete compositions were prepared according to a composition formula for Examples and Comparative Examples set forth in Table 7 below. The respective concrete compositions of Examples and Comparative Examples, which were respectively assigned to the same number in Table 7, were prepared under the same manufacturing conditions, except that compositions of Examples contain 50% by volume of slag balls in fine aggregates.

TABLE 7

| | | | | Mixing weight(□/m³) | | | | |
|---|---|---|---|---|---|---|---|---|
| Example | Gmax | Water/ | S/a | | | | | Coarse aggregates |
| No. | (□) | Cement | (%) | Water | Cement | Sand | Slag balls | (G) |
| Comp. Ex. | 25 | 45 | 43 | 156 | 346 | 764 | — | 1041 |
| 3-1 | | | | | | | | |
| Ex. 3-1 | 25 | 45 | 43 | 156 | 346 | 382 | 526 | 1041 |
| Comp. Ex. | 25 | 50 | 42 | 167 | 334 | 739 | — | 1048 |
| 3-2 | | | | | | | | |
| Ex. 3-2 | 25 | 50 | 42 | 167 | 334 | 370 | 509 | 1048 |
| Comp. Ex. | 25 | 53 | 43 | 167 | 315 | 764 | — | 1039 |
| 3-3 | | | | | | | | |
| Ex. 3-3 | 25 | 53 | 43 | 167 | 315 | 382 | 526 | 1039 |

Test concrete specimens were prepared from concrete compositions given in Table 7 above and compressive strength therebetween was compared according to the corresponding aging period. In addition, on Day 28 of aging, flexural strength of the respective specimens was measured.

TABLE 8

| | Compressive strength (MPa) | | | Flexural strength (MPa) |
|---|---|---|---|---|
| Example No. | Day 7 | Day 28 | Day 91 | Day 28 |
| Comp. Ex. 3-1 | 25.6 | 29.9 | 34.7 | 7.7 |
| Ex. 3-1 | 30.9 | 34.4 | 47.3 | 8.9 |
| Comp. Ex. 3-2 | 20.1 | 24.3 | 31.7 | 6.9 |
| Ex. 3-2 | 23.2 | 34.3 | 41.4 | 8.5 |
| Comp. Ex. 3-3 | 19.8 | 21.3 | 23.6 | 6.4 |
| Ex. 3-3 | 28.5 | 34.3 | 42.9 | 8.0 |

As can be seen from comparison results between the respective Examples and Comparative Examples, the respective Examples exhibited 1.31 to 1.82-fold higher compressive strength as compared to the corresponding Comparative Examples. In addition, the concrete compositions of Examples according to the present invention also exhibited significantly higher flexural strength as compared to those of the corresponding Comparative Examples.

### Example 4

In order to examine radioactive-shielding performance exerted by replacement of sand in fine aggregates with slag balls, concrete compositions were prepared according to the composition formula set forth in Table 9. The water/cement ratio relative to the corresponding composition conditions was adjusted to 35%, followed by performance of tests.

TABLE 9

| | | | | | Moxing weight (□/m³) | | | | |
|---|---|---|---|---|---|---|---|---|---|
| | | | | High- | | | | | Coarse |
| | Slag ball- | | Fine | performance | | | | | aggregate |
| Ex | replacement | Target | aggregate | water | | | | Slag | (crushed |
| No | ratio | slump | ratio(%) | reducing | Water | Cement | Sand | ball | stone) |
| 4-1 | 0 | 18 ± 2 | 46 | 0.5 | 175 | 500 | 743 | 0 | 872 |
| 4-2 | 25 | 18 ± 2 | 46 | 0.5 | 175 | 500 | 557 | 257 | 872 |
| 4-3 | 50 | 18 ± 2 | 46 | 0.5 | 175 | 500 | 371 | 514 | 872 |
| 4-4 | 75 | 18 ± 2 | 46 | 0.5 | 175 | 500 | 186 | 771 | 872 |
| 4-5 | 100 | 18 ± 2 | 46 | 0.5 | 175 | 500 | 0 | 1028 | 872 |

Table 9 was given to examine changes in radioactive-shielding performance with varying replacement ratios of slag balls, wherein the replacement ratios of slag balls in fine aggregates were respectively set to 0, 25, 50, 75 and 100% based on the volume. Saturated surface-dry density, radioactive-shielding performance and shielding rate of concrete compositions, which were prepared under conditions set forth in Table 9, were respectively measured in triplicate and averaged. The results thus obtained are shown in Table 10.

TABLE 10

| Example | | Shielding | |
|---|---|---|---|
| No. | Saturated surface-dry | performance | Shielding rate (%) |
| 4-1 | 2.32 | 7.5 | 73.3 |
| 4-2 | 2.42 | 7.2 | 74.3 |
| 4-3 | 2.50 | 6.9 | 75.6 |
| 4-4 | 2.56 | 6.7 | 76.4 |
| 4-5 | 2.67 | 6.3 | 77.6 |

In Table 10, as for shielding performance lower numerical values represent better shielding performance. As can be seen from the results of Table 10, the higher slag ball-replacement ratios result in improved shielding performance and shielding rate. Using the test results on shielding performance as basic data, computer-coded shield analysis was performed. From the results of shield analysis thus obtained, it was evaluated that the respective concrete compositions exhibited substantially no significant difference in neutron-shielding effects therebetween, but exhibited superior shielding effects against photon beams such as gamma rays. In addition, it could be seen that when the slag ball-replacement ratio is more than 50% by volume, the concrete compositions can be utilized as a concrete composition having superior shielding capability.

### EXAMPLE 5

As discussed hereinbefore, slag balls are produced from steelmaking slag and contain a lot of iron, and therefore have a high self-weight. Therefore, when a concrete composition is prepared utilizing such slag balls and it is intended to use the resulting concrete composition in an application where there is a weight restriction, such as concrete bricks, it is impossible to employ the slag balls alone. To this end, in order to countervail the problems associated with heavy self-weight of slag balls, it is necessary to use combination of slag balls with granulated blast furnace slag as fine aggregates. Table 11 below shows composition examples for using a slag ball-containing concrete composition according to the present invention as concrete bricks. Bricks shown in Table 11 have a size of 190 mm (width)×90 mm (length)×57 mm (height).

TABLE 11

| | Mixing ratio (v/v) | | | | Com- |
|---|---|---|---|---|---|
| | Granu- | | | Brick | pressive |
| Example | lated | Slag | | weight | strength |
| No. | slag | balls | Cement | (g/EA) | (MPa) |
| 5-1 | 1 | 7 | 1 | 334 | 12.7 |
| 5-2 | 2 | 6 | 1 | 312 | 9.1 |
| 5-3 | 3 | 5 | 1 | 302 | 8.8 |
| 5-4 | 4 | 4 | 1 | 285 | 8.7 |
| 5-5 | 5 | 3 | 1 | 270 | 8.5 |
| 5-6 | 6 | 2 | 1 | 266 | 8.2 |
| 5-7 | 7 | 1 | 1 | 246 | 7.8 |

As can be seen from Table 11, the weight and compressive strength of concrete brick increases as the ratio of slag balls becomes higher. Meanwhile, it is preferred that the compressive strength of concrete brick is higher, while the weight thereof is required to be controlled within the predetermined range. In this connection, the brick used in this Example is preferred to have a weight of 250 to 270 g. Based on these criteria, the preferred ratio of slag balls: granulated slag is within a range of 2:6 to 4:4 (v/v).

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A concrete composition comprising water, cement, coarse aggregates having a particle size of more than 5 mm, fine aggregates having a particle size of less than 5 mm, optional additives, and the balance of other inevitable impurities, wherein the fine aggregates include more than 30% by volume of atomized slag balls.

2. The concrete composition for high-strength lean-mix concrete according to claim 1, wherein the fine aggregates include more than 50% by volume of atomized slag balls.

3. The concrete composition for surface-layer concrete having high strength and high abrasion resistance according to claim 1, wherein the fine aggregates include more than 30% by volume of atomized slag balls.

4. The normal-strength concrete composition having superior strength according to claim 1, wherein the fine aggregates include 30 to 50% by volume of atomized slag balls.

5. The radioactive-shielding concrete composition according to claim 1, wherein the fine aggregates include more than 50% by volume of atomized slag balls.

6. The composition according to claim 2, wherein the concrete composition includes 50 to 80 kg of water, 140 to 170 kg of cement, 800 to 1,600 kg of slag balls, 0 to 600 kg of sand, 1,200 to 1,300 kg of coarse aggregates, optional additives, and the balance of other inevitable impurities, per m³ of the concrete composition.

7. The composition according to claim 3, wherein the concrete composition includes 140 to 160 kg of water, 300 to 350 kg of cement, 200 to 1,000 kg of slag balls, 0 to 500 kg of sand, 1,000 to 1,100 kg of coarse aggregates, optional additives, and the balance of other inevitable impurities, per m³ of the concrete composition.

8. The composition according to claim 4, wherein the concrete composition includes 150 to 180 kg of water, 300 to 350 kg of cement, 300 to 550 kg of slag balls, 370 to 520 kg of sand, 1,000 to 1,100 kg of coarse aggregates, optional additives, and the balance of other inevitable impurities, per m³ of the concrete composition.

9. The composition according to claim 5, wherein the concrete composition includes 160 to 180 kg of water, 450 to 550 kg of cement, 500 to 1,000 kg of precious slag (PS) balls, 0 to 370 kg of sand, 870 to 970 kg of coarse aggregates, optional additives, and the balance of other inevitable impurities, per m³ of the concrete composition.

10. A high-strength concrete block comprising 2 to 4-fold by volume of blast furnace slag (BF slag) and 4 to 6-fold by volume of slag balls, per volume of cement.

11. The high strength concrete block according to claim 10, wherein the blast furnace slag and slag balls are included in a ratio of 2:6 to 4:4 (v/v).
